(19) United States
(12) Patent Application Publication
(10) Pub. No.: US 2010/0265487 A1
(43) Pub. Date: Oct. 21, 2010

(54) LITHOGRAPHIC APPARATUS, POSITIONING SYSTEM, AND POSITIONING METHOD

(75) Inventor: Erik Marie José SMEETS, Prinsenbeek (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/726,569

(22) Filed: Mar. 18, 2010

Related U.S. Application Data
(60) Provisional application No. 61/169,566, filed on Apr. 15, 2009.

(51) Int. Cl. G03B 27/58; G05B 9/02; G05D 3/12; G05B 9/03

(52) U.S. Cl. 355/72; 700/110; 700/114

(57) ABSTRACT

A positioning system for a lithographic apparatus including a control system to position a moveable object of the lithographic apparatus in at least one direction which is substantially parallel to a frame, the control system including a measurement system to measure a position of the moveable object, an actuator to apply a force to the moveable object, and a controller to provide a drive signal to the actuator based on an output of the measurement system; and an emergency brake system configured to determine a failure of the control system, and if the failure is determined disable the control system and pull the moveable object against the frame.

### CROSS REFERENCE TO RELATED APPLICATIONS

This application claims priority and benefit under 35 U.S.C. §119(e) to U.S. Provisional Patent Application No. 61/169,566, entitled “Lithographic Apparatus, Positioning System, and Positioning Method”, filed on Apr. 15, 2009. The content of that application is incorporated herein in its entirety by reference.

### FIELD

The present invention relates to a lithographic apparatus, a positioning system for a lithographic apparatus, and a positioning method for a lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

A lithographic apparatus may include one or more moveable objects, for instance the aforementioned substrate table and/or patterning device. The moveable object can be positioned by a control system with respect to a frame, for instance a metrology frame or a base frame. The control system includes a measurement system to measure a position of the moveable object, an actuator to apply forces to the moveable object, and a controller to provide a drive signal to the actuator based on an output of the measurement system.

An important issue is what to do if the control system fails due to for instance a power interruption, or failure of a component of the control system. In some embodiments, the emergency strategy is to disable the control system, so that friction between the moveable object and the frame decreases the kinetic energy of the moveable object. Any remaining kinetic energy is then dissipated when the moveable object collides with its surroundings.

However, the increasing demands in possible throughput of the lithographic apparatus and thus the increasing demands in speed of the moveable object within a limited amount of space, and position accuracy has resulted in the use of lightweight materials, sensitive components, high accelerations and a small distance between the moveable object and its surroundings, resulting in an impact sensitive system. The current emergency strategy may no longer suffice to prevent the moveable object (and its surroundings) from being damaged when the moveable object collides with its surroundings. If the moveable object is damaged, this also means undesired downtime of the lithographic apparatus to repair or replace the moveable object and/or to repair the lithographic apparatus, which is costly.

### SUMMARY

It is desirable to provide a lithographic apparatus with an improved emergency strategy.

According to an embodiment of the invention, there is provided a positioning system for a lithographic apparatus including a control system to position a moveable object of the lithographic apparatus in at least one direction which is substantially parallel to a frame, the control system including a measurement system to measure a position of the moveable object, an actuator to apply forces to the moveable object, and a controller to provide a drive signal to the actuator based on an output of the measurement system; and an emergency brake system configured to: determine a failure of the control system, and when or if the failure is determined disable the control system and pull the moveable object against the frame.

According to another embodiment of the invention, there is provided a lithographic apparatus including an illumination system configured to condition a radiation beam; a support constructed to support a patterning device, the patterning device being capable of imparting the radiation beam with a pattern in its cross-section to form a patterned radiation beam; a substrate table constructed to hold a substrate; a projection system configured to project the patterned radiation beam onto a target portion of the substrate; and a positioning system including a control system to position a moveable object of the lithographic apparatus in at least one direction which is parallel to a frame, the control system including a measurement system to measure a position of the moveable object, an actuator to apply forces to the moveable object, and a controller to provide a drive signal to the actuator based on an output of the measurement system; and an emergency brake system configured to determine a failure of the control system, and when or if the failure is determined disable the control system and pull the moveable object against the frame.

According to yet another embodiment of the invention, there is provided a positioning method for a lithographic apparatus including positioning a moveable object of the lithographic apparatus in at least one direction which is parallel to a frame by a control system; determining a failure of the control system by an emergency brake system; and when of if the failure is determined disabling the control system by the emergency brake system; and pulling the moveable object against the frame by the emergency brake system.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a schematic representation of a lithographic apparatus according to another embodiment of the invention;

FIG. 3 depicts a schematic representation of a positioning system according to yet another embodiment of the invention; and

FIG. 4 depicts a schematic representation of various ways to decrease the kinetic energy of a moveable object by an emergency brake system according to the embodiment of FIG. 3.

### DETAILED DESCRIPTION

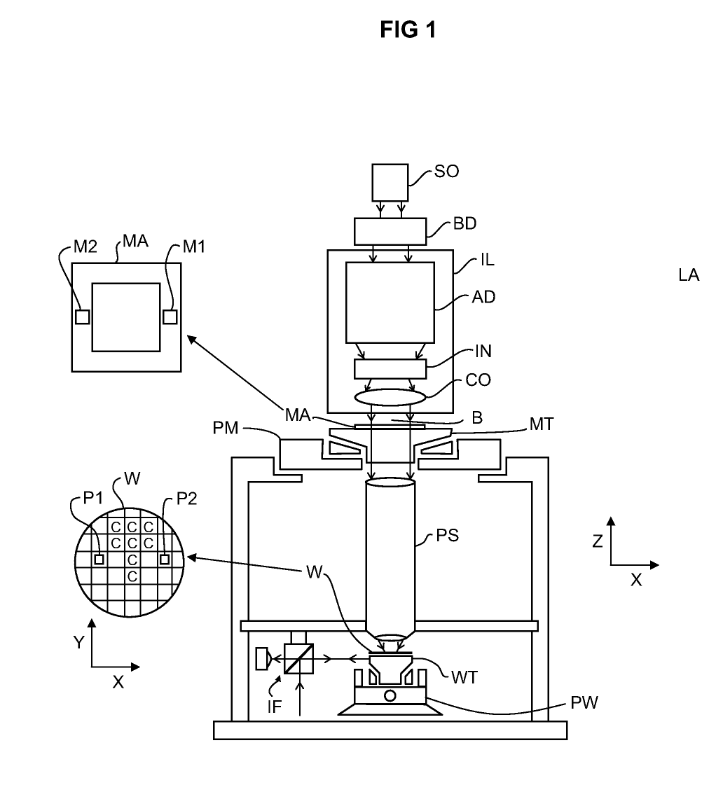

FIG. 1 schematically depicts a lithographic apparatus LA according to one embodiment of the invention. The apparatus includes an illumination system (illuminator) IL configured to condition a radiation beam B (e.g. UV radiation or any other suitable radiation), a patterning device support or mask support structure (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT or “substrate support” constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The patterning device support holds the patterning device in a manner that depends on the orientation of the patterning device, the design of the lithographic apparatus, and other conditions, such as for example whether or not the patterning device is held in a vacuum surroundings. The patterning device support can use mechanical, vacuum, electrostatic or other clamping techniques to hold the patterning device. The patterning device support may be a frame or a table, for example, which may be fixed or movable as required. The patterning device support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the mask support structure (e.g., mask table) MT, and is patterned by the patterning device. Having traversed the patterning device (e.g. mask) MA, the radiation beam B passes through the projection system PS, which focuses the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the patterning device support (e.g. mask table) MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the patterning device support (e.g. mask table) MT may be connected to a short-stroke actuator only, or may be fixed. Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g. mask) MA, the patterning device alignment marks may be located between the dies.

The depicted apparatus could be used in at least one of the following modes:

1. In step mode, the patterning device support (e.g. mask table) MT or “mask support” and the substrate table WT or “substrate support” are kept essentially stationary, while an entire pattern imparted to the radiation beam is projected onto a target portion C at one time (i.e. a single static exposure). The substrate table WT or “substrate support” is then shifted in the X and/or Y direction so that a different target portion C can be exposed. In step mode, the maximum size of the exposure field limits the size of the target portion C imaged in a single static exposure.

2. In scan mode, the patterning device support (e.g. mask table) MT or “mask support” and the substrate table WT or “substrate support” are scanned synchronously while a pattern imparted to the radiation beam is projected onto a target portion C (i.e. a single dynamic exposure). The velocity and direction of the substrate table WT or “substrate support” relative to the patterning device support (e.g. mask table) MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the patterning device support (e.g. mask table) MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

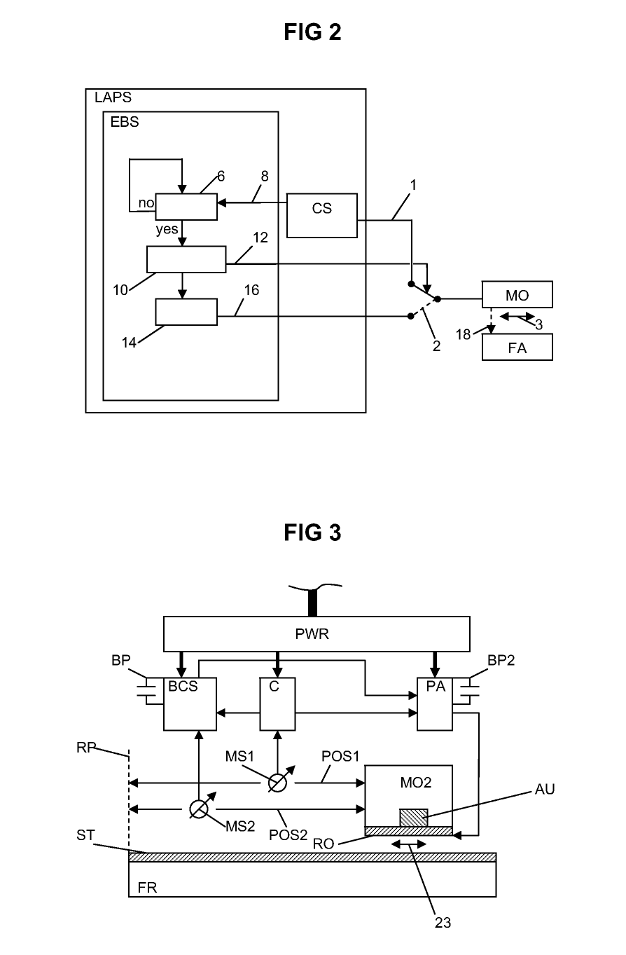

FIG. 2 depicts a schematic representation of a positioning system LAPS according to an embodiment of the invention to be used for instance in the lithographic apparatus of FIG. 1. The lithographic apparatus includes a moveable object MO which is moveable in at least one direction substantially parallel to a frame FA as indicated by arrow 3. The positioning system LAPS includes a control system CS to position the moveable object MO. Not shown in this figure is that the control system CS includes a measurement system to measure a position of the moveable object MO, an actuator to apply a force to the moveable object MO, a power supply, and a controller to provide a drive signal to the actuator based on an output of the measurement system.

The positioning of the moveable object MO by the control system CS is represented by communication line 1, which in this embodiment is connected to the moveable object MO by a switch 2. The switch 2 is a hardware or a software switch. The positioning system LAPS further includes an emergency braking system EBS configured to determine a failure of the control system CS, and if/when the failure is determined configured to disable the control system CS and pull the moveable object MO against the frame FA, as will be described in more detail below.

As shown in FIG. 2, the emergency braking system EBS determines if the control system CS fails or not in block 6. The emergency braking system EBS therefore requires some kind of input from the control system CS or any other system (not shown) monitoring the control system CS. The input from the control system CS or the monitoring system is indicated by arrow 8. When no failure of the control system CS is determined by the emergency brake system EBS and the control system is thus working properly, the emergency brake system will return to block 6 to determine again if the control system CS fails or not. A continuous determining loop can be created in this way, but it is also envisaged that the failure of the control system is checked at discrete time instants, for instance once per millisecond.

The control system CS may fail due to an external cause such as a power drain/surge or an emergency shut down initiated for instance by pressing an emergency button by personnel, or due to an internal cause, such as failure of one or more components of the control system CS. Typical components in a control system are power supply, amplifier, measurement system, computer software, communication lines, etc. In case the control system CS fails, this is detected by the emergence brake system EBS in block 6 after which the emergency brake system continues to block 7, indicating that upon failure of the control system CS, the emergency brake system EBS will disable 10 the control system CS by switching the switch 2. The disabling action is indicated by an arrow 12 pointing towards the switch 2.

It is noted here that disabling the control system CS should be interpreted as that the emergency brake system EBS has control over the moveable object MO instead of the control system CS, which can be achieved by active disconnecting hardware components with switches or a software routine, or passive disconnecting. At least an action is required from the emergency brake system EBS in case of active disconnecting. An example of when active disconnecting is required is in case the control system CS is still able to apply forces to the moveable object MO, but is not able to properly position the moveable object MO. Not disconnecting the control system CS would then result in a “struggle” between the control system CS and the emergency brake system EBS, which is not desirable unless the emergence brake system EBS is able to compensate the failing control system CS. Preferably, the control system CS is disconnected from the moveable object by breaking communication between the controller and the actuator.

No action may be required from the emergency brake system EBS in case of passive disconnecting, i.e. when the control system CS is automatically disconnected from the moveable object MO when the control system CS fails. An example of such a situation is when the power to the control system is interrupted, i.e. the EBS must come into action.

Preferably, the control system is actively disconnected from the moveable object, so that it is ensured at all times that the control system has no control over the moveable object anymore.

After disabling the control system CS, the emergency brake system EBS takes over control of the moveable object MO and will subsequently pull the moveable object MO against the frame FA as indicated by block 14. The pulling action itself is indicated by dashed arrow 18, and the fact that the pulling action is initiated by the emergency brake system EBS is indicated by communication line 16.

The pulling action can be done using the actuator of the control system CS, but it is also possible that the emergency brake system EBS includes an auxiliary actuator (not shown) to pull the moveable object against the frame.

The pulling action 18 will increase the friction between the moveable object MO and the frame FA thereby reducing the kinetic energy of the moveable object MO faster and decreasing a brake distance of the moveable object MO. The reduction in kinetic energy may result in a full stop of the moveable object MO before it collides with its surroundings, or the moveable object MO is at least slowed down before colliding, preferably to such an extent that damaging the moveable object MO or other components of the lithographic apparatus LA is prevented. As the remaining velocity of the moveable object MO when colliding with its surroundings is determined by the position, the initial velocity and acceleration, the pulling force and direction, and the direction of the moveable object MO, the pulling action 18 by the emergency brake system EBS is at least capable of decreasing the chance of damaging the lithographic apparatus LA when the control system CS fails and thus reduces the undesired downtime of the lithographic apparatus LA.

Preferably, the emergency brake system EBS pulls the moveable object MO against the frame FA in such a way that the chance of damage is minimized. This can for instance be done by increasing the friction between the moveable object MO and the frame FA by means of pulling the moveable object MO harder against the frame FA or by increasing a coefficient of friction between the moveable object MO and the frame FA.

After pulling the moveable object MO against the frame FA further action may be required. The further actions may include sending an error signal to an operator or operating system, resetting the control system CS, or taking further safety precautions.

FIG. 3 depicts a schematic representation of a positioning system according to an embodiment of the invention, which is suitable for the lithographic apparatus of FIG. 1. The positioning system includes a control system to position a moveable object MO2 in at least one direction 23 substantially parallel to a frame FR, and an emergency brake system configured to determine a failure of the control system, and when the failure is determined, configured to disable the control system and pull the moveable object MO2 against the frame FR. The control system is configured to position the moveable object MO2 with respect to the frame FR, but it can also be configured to position the moveable object with respect to another object.

The control system includes a measurement system MS 1 configured to measure a position POS1 of the moveable object MO2 with respect to a reference point RP on the frame FR. The reference point RP can be any point on the frame FR, but can also be any other point which is suitable as an origin for positioning the moveable object MO2.

The control system further includes an actuator, in this embodiment an electromagnetic actuator, configured to apply forces to the moveable object MO2. The actuator has a stator part ST in the frame FR, a rotor part RO in the moveable object MO2, and a power amplifier PA configured to supply power to the actuator based on a drive signal. In this embodiment, the stator part ST includes permanent magnets, and the rotor part RO includes coils which are connected to the power amplifier PA. Alternatively, the reversed case, wherein the coils are situated in the stator part ST and the magnets in the rotor part RO, is also possible.

Between the measurement system MS1 and the power amplifier PA of the electromagnetic actuator, a controller C is provided to provide a drive signal to the actuator based on an output of the measurement system MS1. Both the controller C and the actuator are powered by a power supply PWR. The power supply PWR draws power from a power grid over power line PL.

The control system may fail due to failure of the measurement system MS1, failure of the controller C, a power surge/drain in the power line PL (external cause) or a power interruption due to failure of the power supply PWR (internal cause), and failure of communication lines between the aforementioned components of the control system.

The emergency brake system includes a backup measurement system MS2 to measure a position POS2 of the moveable object with respect to the reference point RP or any other reference point.

The emergency brake system further includes a backup control system BCS configured to compare an output of the backup measurement system MS2 and an output of the control system, in this case the output of the controller C, to determine if the control system fails. The backup control system BCS is further configured to provide a drive signal to the actuator to pull the moveable object MO2 against the frame FR if the control system fails. The backup control system BCS is in this embodiment also powered by the power supply PWR, but can also have its own power supply independent of the power supply PWR. Alternatively, the backup control system BCS may be configured to provide a drive signal to an auxiliary power amplifier that is connected to an actuator. AU to pull the moveable object MO2 against the frame FR. This is beneficial in case the actuator is failing. The auxiliary actuator AU may include a coil cooperating with the permanent magnets in the stator ST of the actuator.

The emergency brake system also includes a backup power supply BP, BP2 to supply power to the backup control system BCS and the power amplifier PA of the electromagnetic actuator in case the power supply PWR or PL fails. The backup power supply BP, BP2 is shown here as a capacity, but may take any form which is independent of the normal power supply PWR, for instance a battery.

The backup emergency system in this embodiment determines the failure of the control system by comparing the measured position POS2 with the control state of the controller C. Various ways are possible to determine the failure. An example is that failure of the control system is determined when the desired position of the moveable object MO2 deviates too much from the measured position. The allowable deviation can be a predetermined value based on specifications of the controller or control system. Another example is that failure of the control system is determined when no signal is received anymore from the controller C.

Alternatively or additionally, failure of the control system may also be determined by the following methods: monitoring a position quantity of the moveable object, such as position, velocity or acceleration, preferably monitoring multiple position quantities, so that errors can be detected by looking at the position quantity itself and detect sudden jumps in data, or by comparing different position quantities, which can be advantageous to determine if the moveable object MO2 is really standing still; measuring if the power levels of power supplies are above a predetermined value; checking communication lines between for instance backup control system and power amplifiers, for instance by toggling data; and checking software outputs, preferably based on a position quantity of the moveable object, to see if the software is still running

The person skilled in the art will recognize that depending on the components of the control system and the different failure mechanisms, there are various ways to detect a failure of the control system.

The backup control system BCS may further be configured to determine a failure of the backup measurement system MS2. In case, the backup measurement system MS2 is failing, the emergency brake system should not intervene in case the control system fails, as it may make the situation worse. In this case, the normal/default control system brings the MO down to a zero kinetic energy state.

In this embodiment, the power amplifier PA is provided with a dual input. Based on a signal from the backup control system BCS, the power amplifier switches to the right input, so that in case the control system is functioning properly, the power amplifier PA functions based on an output from the controller C, and in case the control system fails, the power amplifier PA switches to the backup control system BCS, so that the power amplifier functions based on an output from the backup control system BCS. In this way, the emergency brake system disconnects the controller from the actuator, so that the control system is no longer able to position the moveable object MO2.

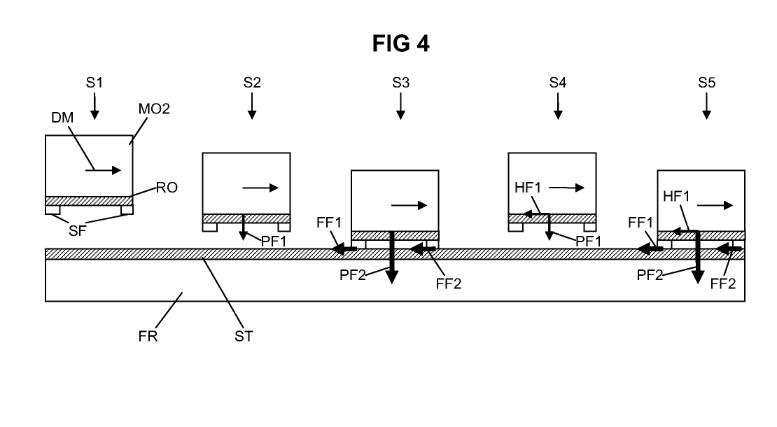

Various ways in which the backup control system BCS is able to drive the actuator or auxiliary actuator will now be described with reference to FIG. 4.

FIG. 4 depicts various ways to drive the actuator by the backup control system BCS of FIG. 3, but also applies to other embodiments of the invention. For simplicity reasons, the reference numerals and letters are similar to the ones used in the embodiment of FIG. 3. FIG. 4 shows the situation that the backup control system BCS provides a drive signal to the actuator, but the same applies to the situation that the backup control system BCS provides a drive signal to the auxiliary actuator.

FIG. 4 shows five distinct situations S1, S2, S3, S4, and S5. Situation S1 is the situation in which the moveable object MO2 is not in contact with the frame FR, because the electromagnetic actuator including the stator part ST and the rotor part RO was driven in such a way by the control system that the moveable object MO2 is levitated. Situation S1 shows the moveable object at a time instant just after failure of the control system and before the emergency brake system takes over control of the position of the moveable object MO2. In this example, the moveable object MO2 has a direction of motion DM to the right.

The moveable object MO2 here includes two sliding elements in the form of sliding feet SF which are arranged between the moveable object MO2 and the frame FR. The sliding feet SF are designed to provide a predictable friction behavior, preferably even in case the frame FR is covered by a layer of water or other liquid due to an emersion type lithographic process. On the other hand, the sliding feet have to be designed to be wear resistant or at least that particles that are generated can easily be captured by a cleaning system in the frame. Preferably, the sliding feet are made of PEEK (polyaryletheretherketone).

The backup control system BCS of FIG. 3 may be configured to passively wait until the moveable object MO2 comes into contact with the frame FR due to for instance gravity, after which the moveable object MO2 is pulled against the frame FR. In this case, situation S3 follows situation S1. When the moveable object MO2 comes into contact with the frame FR, the backup control system BCS provides a drive signal to the actuator, such that a second pulling force PF2 is applied to the moveable object MO2 towards the frame FR. The second pulling force PF2 will result in friction between the sliding feet SF and the frame FR indicated by friction forces FF1 and FF2. As the friction forces FF1, FF2 are directed opposite to the direction of motion DM, the kinetic energy of the moveable object MO2 is reduced and the chance of a collision is decreased. And if the moveable object MO2 collides with its surroundings, the velocity of the moveable object MO2 is preferably low enough to cause no serious damage.

The second pulling force PF2 may be applied a certain (constant) time interval after failure of the control system is detected, but as the distance between and the frame is variable, the second pulling force is preferably applied substantially when the moveable object touches the frame, so that slowing the moveable object down due to the second pulling force is started as fast as possible thereby further reducing the chance of a collision between the moveable object and its surroundings.

Additionally, the backup control system BCS may provide a drive signal to the actuator such that the moveable object MO2 is already pulled towards the frame FR while still being levitated, i.e. when there is no contact between frame FR and moveable object MO2. This is shown in situation S2, which will then follow situation S1 but occurs before situation S3. In situation S2, the actuator applies a first pulling force PF1 to the moveable object MO2 towards the frame FR. This will decrease the time that the moveable object MO2 is in the air and will thus result in a moveable object MO2 that comes quicker into contact with the frame FR so that the friction forces FF1 and FF2 will be applied faster, thereby reducing the kinetic energy of the moveable object MO2 at an earlier stage. In most cases, the first pulling force PF1 is smaller than the second pulling force PF2, as the impact between the moveable object MO2 and the frame FR should be such that no damage or loss of machine availability due to (re) calibration, while the friction forces FF1 and FF2 should preferably be as high as possible to minimize the chance of colliding. It is noted here that increasing the second pulling force PF2 will result in increased friction forces FF1 and FF2 as will be readily understood by a person skilled in the art.

The sliding feet SF are beneficial as they provide a predictable friction behavior between the moveable object MO2 and the frame FR. The sliding feet may also be designed to have certain wear characteristics and particle generation characteristics, which can be beneficial in low pressure/vacuum environments.

In a preferred embodiment, the first (if applicable) and second pulling force PF 1 and PF2 are directed obliquely away from the direction of motion DM, such that the first and second pulling force PF1, PF2 are partially directed opposite to the direction of motion DM. In this way, it is guaranteed that there is no force in the direction of motion DM of the moveable object MO2 due to commutation errors, which may be the result of the backup measurement system MS2 which is preferably used for commutation of the electromagnetic actuator and may be less precise as the measurement system MS1 of the control system used for commutation during normal operation.

Additionally, the backup control system BCS can be configured to drive the actuator such that a force is applied to the moveable object MO2 which is opposite to the direction of motion DM. This situation is shown in combination with the first pulling force PF1 in situation S4 and in situation S5. In that case, the order of situations is first situation S1, followed by situations S4 and S5 respectively.

In situation S4 a horizontal force HF1 is shown while the moveable object MO2 is still in the air, the horizontal force HF1 being opposite to the direction of motion DM. This is beneficial as the force HF1 already decreases the velocity of the moveable object MO2 while the moveable object MO2 is still in the air, thereby already decreasing the kinetic energy of the moveable object MO2, so that the moveable object MO2 can be put to a full stop earlier, or at least the chance of colliding is reduced, and when the moveable object MO2 collides, the velocity is preferably small enough to cause no damage.

The same force HF2 can be applied to the moveable object MO2 when the moveable object MO2 is in contact with the frame FR as is shown in situation S5. Both the horizontal force HF1 and the friction forces FF1, FF2 due to the second pulling force PF2 are directed opposite to the direction of motion DM, so that the total force acting in a direction opposite to the direction of motion DM is increased, thereby reducing the kinetic energy at a higher rate. Preferably, the horizontal force HF1 is removed when the moveable object MO2 has come to a full stop with respect to the frame FR, or alternatively when the velocity is below a predetermined value, to avoid that the moveable object is accelerated in the opposite direction.

It is also possible that moveable object MO2 is not levitated at all during normal operation, in that case, only situations S3 and S5 apply.

It is further noted that the situations of FIG. 4 also apply to other embodiments of the invention including embodiments which do not include electromagnetic actuators. Pulling the moveable object to a frame can for instance also be done using air bearings.

The moveable object can be any moveable part of the lithographic apparatus, but is preferably a substrate table or a patterning device of a lithographic apparatus. It may also apply to supports that support a substrate or patterning device if applicable.

The above embodiments also apply to moveable objects and corresponding control systems that position the moveable object in more than one degree of freedom, but parallel to a frame. For simplicity reasons, the embodiments in the Figures only show the one degree of freedom situation. The principles of the invention do not change, at the most the complexity. If a moveable object is positioned in more than one degree of freedom, for instance in a plane parallel to a frame, there is a situation possible that the moveable object is moving in one direction, and the emergency brake system is reducing the velocity. In that case, it is preferred that the errors in the direction of a pulling force are small enough to avoid that there is a force component in a direction perpendicular to the direction of motion, and the moveable object is accelerated in that direction. It is also possible to detect accelerations in the direction perpendicular to the direction of motion and adjust the direction of the pulling force based on this information.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A positioning system for a lithographic apparatus, the positioning system comprising:
a control system configured to position a moveable object of the lithographic apparatus in at least one direction which is substantially parallel to a frame, the control system comprising
a measurement system configured to measure a position of the moveable object,
an actuator configured to apply a force to the moveable object, and
a controller configured to provide a drive signal to the actuator based on an output of the measurement system; and
an emergency brake system configured to determine a failure of the control system, and if the failure is determined, disable the control system and pull the moveable object against the frame.

2. The positioning system of claim 1, wherein the emergency brake system comprises:
a backup measurement system configured to measure the position of the moveable object;
a backup power supply configured to supply power to the actuator; and
a backup control system configured to compare an output of the backup measurement system and an output of the control system to determine a failure of the control system, and if the failure is determined, provide a drive signal to the actuator to pull the moveable object against the frame.

3. The positioning system of claim 1, wherein the emergency brake system comprises:
a backup measurement system configured to measure the position of the moveable object;
an auxiliary actuator configured to apply a force to the moveable object; and
a backup control system configured to compare an output of the backup measurement system and an output of the control system to determine a failure of the control system, and if the failure is determined, provide a drive signal to the auxiliary actuator to pull the moveable object against the frame.

4. The positioning system of claim 2, wherein the backup control system is configured to apply a force to the moveable object in a direction substantially opposite to a direction of motion of the moveable object if the failure is determined.

5. The positioning system according of claim 2, wherein the control system is configured to levitate the moveable object with the actuator, and if the failure is determined the backup control system is configured to
apply a first pulling force to the moveable object towards the frame when the moveable object is not in contact with the frame; and
apply a second pulling force to the moveable object towards the frame when the moveable object is in contact with the frame.

6. The positioning system of claim 5, wherein the first and second pulling force are directed obliquely towards the frame and in a direction opposite to a direction of motion of the moveable object.

7. The positioning system of claim 1, wherein the emergency brake system comprises a sliding element arranged between the moveable object and the frame.

8. The positioning system of claim 1,wherein the moveable object is positionable in two directions which are substantially parallel to the frame by the control system.

9. A lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate table constructed to hold a substrate;
a projection system configured to project the patterned radiation beam onto a target portion of the substrate; and
a positioning system comprising
a control system configured to position a moveable object of the lithographic apparatus in at least one direction which is substantially parallel to a frame, the control system comprising
a measurement system configured to measure a position of the moveable object,
an actuator configured to apply a force to the moveable object, and
a controller configured to provide a drive signal to the actuator based on an output of the measurement system; and
an emergency brake system configured to determine a failure of the control system, and if the failure is determined, disable the control system and pull the moveable object against the frame.

10. The lithographic apparatus of claim 9, wherein the moveable object is the substrate table.

11. A positioning method for a lithographic apparatus, the method comprising:
positioning a moveable object of the lithographic apparatus in at least one direction which is substantially parallel to a frame by a control system;
determining a failure of the control system by an emergency brake system;
and if the failure is determined disabling the control system by the emergency brake system, and pulling the moveable object against the frame by the emergency brake system.

12. The positioning method of claim 11, comprising
measuring the position of the moveable object by a backup measurement system of the emergency brake system;
determining the failure of the control system by a backup control system of the emergency brake system; and
providing a drive signal to an actuator by the backup control system, the actuator being arranged to apply a force to the moveable object, to pull the moveable object against the frame.

13. The positioning method of claim 12, comprising applying the force to the moveable object by the backup control system in a direction substantially opposite to a direction of motion of the moveable object if the failure is determined.

14. The positioning method of claim 12, comprising
levitating the moveable object by the control system;
and if the failure is determined applying a first pulling force to the moveable object by the backup control system towards the frame when the moveable object is not in contact with the frame, and applying a second pulling force to the moveable object by the backup control system towards the frame when the moveable object is in contact with the frame.

15. The positioning method of claim 14, wherein the first and second pulling forces are directed obliquely towards the frame and in a direction opposite to a direction of motion of the moveable object.

16. The positioning method of claim 11, wherein the moveable object is a substrate table.
